(19) United States
(12) Patent Application Publication
(10) Pub. No.: US 2008/0022704 A1
(43) Pub. Date: Jan. 31, 2008

(54) Air conditioner and method of controlling air conditioner

(75) Inventor: Kazuhiro Fukuta, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/880,842

(22) Filed: Jul. 24, 2007

(30) Foreign Application Priority Data
Jul. 31, 2006 (JP) 2006-208674

(51) Int. Cl. F24F 11/02; B60H 1/32

(52) U.S. Cl. 62/172; 62/244

(57) ABSTRACT

An air conditioner comprises: a refrigerating cycle including a compressor and an evaporator; a heater core for heating the air that has passed through the evaporator; a first sensor for acquiring information related to a temperature of the evaporator; a second sensor for acquiring information related to a temperature of a medium to supply heat to the heater core; and a compressor control unit for controlling the compressor. When the temperature of the evaporator is not higher than a predetermined threshold temperature, the compressor control unit reduces a ratio of compression of the refrigerant by the compressor. When the temperature of the medium is not more than a first predetermined value, the compressor control unit sets the threshold temperature at a value higher than a frost limit temperature of the evaporator.

The applicant claims the right of priority based on Japanese Patent Application JP 2006-208674, filed on Jul. 31, 2006, and the entire content of JP-2006-208674 is hereby incorporated by reference.

### FIELD OF THE INVENTION

The present invention relates to an air conditioner and a method of controlling the air conditioner. More particularly, the present invention relates to an air conditioner and a method of controlling the air conditioner by which an operator cab is heated and a windshield of the operator cab is defogged at the same time.

### BACKGROUND OF THE INVENTION

Recently, strict emission control laws have been enacted. Accordingly, there is a tendency for heat produced by an engine mounted on a construction vehicle such as a hydraulic excavator is reduced. Therefore, an air conditioner for a vehicle, which warms up blown air by a heater core utilizing an engine coolant, cannot sufficiently warm up an operator cab in some cases, especially when idling in winter, since the temperature of the engine coolant is too low. In order to defog a windshield of the operator cab, even while the operator cab is warmed up, such air conditioner activates a refrigerating cycle and makes an evaporator, which is incorporated into the refrigerating cycle, exchange heat between the blown air and refrigerant. In this case, the blown air which has cooled by the evaporator, flows into a heater core, and the temperature of the coolant is decreased. As the result, the temperature of the operator cab further decreases. Many air conditioners mounted on construction vehicles do not have a full outside air mode, in which air to be supplied to the air conditioner is only obtained from the outside, in order to prevent an outside air filter from clogging. That is, air in the operator cab is always supplied to the air conditioner. Therefore, it is difficult to decrease the temperature of the evaporator of the air conditioner until the evaporator is frosted over. As a result, the refrigerating cycle of the air conditioner continues to operate, and the operating time of the refrigerating cycle of the air conditioner mounted in the construction vehicle is longer than that of an air conditioner mounted in a common passenger car. Therefore, in the air conditioner mounted in the construction vehicle, blown air which has been cooled by the evaporator, flows into a heater core for a prolonged period of time. Accordingly, the temperature of the coolant is further decreased and thereby heating capacity of the air conditioner is reduced.

In order to solve the above problem, an idling control device is disclosed in Patent Document 1. This type of idling control device is operated as follows. When coolant temperature is low, engine speed when idling and when stopping a vehicle is adjusted to raise the coolant temperature so that a sufficiently large heating capacity can be provided. However, as described above, in the idling control device described in Patent Document 1, controlling is conducted so that the engine speed can be raised, and as a result engine noise is increased and fuel consumption is increased.

Patent Document 1: Japanese Unexamined Patent Publication No. 2004-324531.

### SUMMARY OF THE INVENTION

An object of the present invention is to provide an air conditioner and a method of controlling the air conditioner while a windshield is being defogged, and having a sufficiently large heating capacity.

Another object of the present invention is to provide an air conditioner and a method of controlling the air conditioner that has a sufficiently large heating capacity without increasing noise and increasing fuel consumption.

According to the first aspect of the present invention, an air conditioner for a vehicle is provided which comprises: a refrigerating cycle having a compressor for compressing refrigerant and also having an evaporator for exchanging heat between the refrigerant and air; a heater core for heating air which has passed through the evaporator; a first sensor for acquiring information related to an evaporator temperature; a second sensor for acquiring information related to a temperature of the medium for supplying heat to the heater core; and a compressor control unit for controlling the compressor. In the air conditioner described above, the compressor control unit operates as follows. In the case where the temperature of the evaporator, which is obtained according to information acquired from the first sensor, is not more than a predetermined threshold temperature, and the compression ratio of refrigerant by the compressor is reduced. In the case where a temperature of the medium which is obtained according to information acquired from the second sensor, is not more than a first predetermined value, the threshold temperature is set at a value higher than the evaporator frost limit temperature.

Due to the above constitution, in the case where a temperature of the medium is low, the refrigerating cycle can be easily stopped. Therefore, it is possible to suppress a decrease in the temperature of the medium. As a result, heating capacity can be enhanced. In this connection, a reduction in the compression ratio of the refrigerant includes a stoppage of compressing the refrigerant, that is, a reduction in the compression ratio of the refrigerant includes a stoppage of the compressor.

It is preferable that the first predetermined value is the minimum temperature of the medium temperature capable of maintaining a temperature of air, which is sent out from the air conditioner when the evaporator temperature is the frost limit temperature, at a value not less than the predetermined temperature. When the first predetermined temperature is set at this temperature, it is possible to maintain a high defogging capacity with a reduction of the heating capacity, which is caused by a reduction of the medium temperature being suppressed.

It is preferable that the compressor control unit sets the threshold temperature at a higher value when the medium temperature becomes lower than the first predetermined temperature. Due to the above constitution, the lower the medium temperature is, the more easily the refrigerating cycle can be stopped. Accordingly, a reduction in the heating capacity caused by a decrease in the medium temperature can be effectively suppressed.

In the case where the medium temperature is not more than the second predetermined temperature which is lower than the first predetermined temperature, it is preferable that the compressor control unit sets the threshold value at a constant value.

Further, it is preferable that the second predetermined value is the maximum temperature of the evaporator capable of defogging a windshield arranged in a region in which air conditioning is performed by the air conditioner. Due to the above constitution, even when the medium temperature is very low, both heating and defogging can be conducted.

Further, it is preferable that an air conditioner comprises a load state judgment unit for judging whether or not a load given to the air conditioner is a heating load and it is also preferable that when the load state judgment unit judges that the load given to the air conditioner is not a heating load, a compressor control unit sets a threshold temperature at a frost limit temperature of the evaporator. Due to the above constitution, it is possible to prevent the occurrence of the refrigerating cycle being frequently stopped and the cooling operation not being sufficiently conducted when the air conditioner is performing a cooling operation.

According to the second aspect of the present invention, there is provided a construction machine having any air conditioner described above by which an operator cab is air-conditioned.

According to the third aspect of the present invention, there is provided a method of controlling an air conditioner comprising a refrigerating cycle having a compressor for compressing refrigerant, and also having an evaporator for exchanging heat between refrigerant and air, and also comprising a heater core for heating air, which has passed through the evaporator. The control method comprises: acquiring an evaporator temperature; acquiring a medium temperature; setting a threshold temperature to determine whether or not a compression ratio of the refrigerant by the compressor is lowered according to the medium temperature; and lowering the compression ratio of the refrigerant by the compressor in the case where the evaporator temperature is not more than the threshold temperature. In the setting of the threshold temperature, in the case where the medium temperature is not more than the first predetermined value, the threshold temperature is set at a value higher than the frost limit temperature of the evaporator.

In the setting of the threshold temperature, it is preferable that the threshold temperature be set at a higher value as the medium temperature becomes lower than the first predetermined value.

### BRIEF DESCRIPTION OF THE DRAWINGS

These and other features and advantages of the present invention will be better understood by reading the following detailed description, taken together with the drawings wherein:

FIG. 1 shows an arrangement view of an operator cab of a vehicle having an air conditioner according to the present invention;

FIG. 2 shows an overall arrangement view of an air conditioner for a vehicle according to the present invention;

FIG. 3 shows a functional block diagram of a controller of an air conditioner for a vehicle;

FIG. 4 shows a graph of the relationship between a coolant temperature and a threshold temperature at which the compressor is stopped;

FIG. 5 shows a flow chart of a compressor control action of an air conditioner for vehicle according to the present invention; and

FIG. 6 shows a flow chart of a compressor control action of an air conditioner for a vehicle according to the present invention.

### DETAILED DESCRIPTION OF THE PREFERRED EMBODIMENT

Referring to the drawings, an air conditioner for a vehicle of the present invention will be explained below. However, it should be noted that the present invention is not limited by the following explanations.

The air conditioner for a vehicle according to the present invention, in order to extend a period of time in which the compressor is stopped, sets an evaporator temperature, at which the compressor of the refrigerating cycle is stopped, at a value higher than a threshold temperature for preventing the evaporator from frosting over, by referring to engine coolant temperature supplied to the heater core. However, a setting range of the evaporator temperature is determined so that a windshield or door of an operator cab can be defogged in the setting range of the evaporator temperature. When the compressor is controlled as described above, in the air conditioner for a vehicle, the temperature of air flowing into the heater core is prevented from decreasing so that heating capacity can be enhanced. In the air conditioner for a vehicle, fuel consumption is enhanced by extending the period of time in which the compressor is stopped.

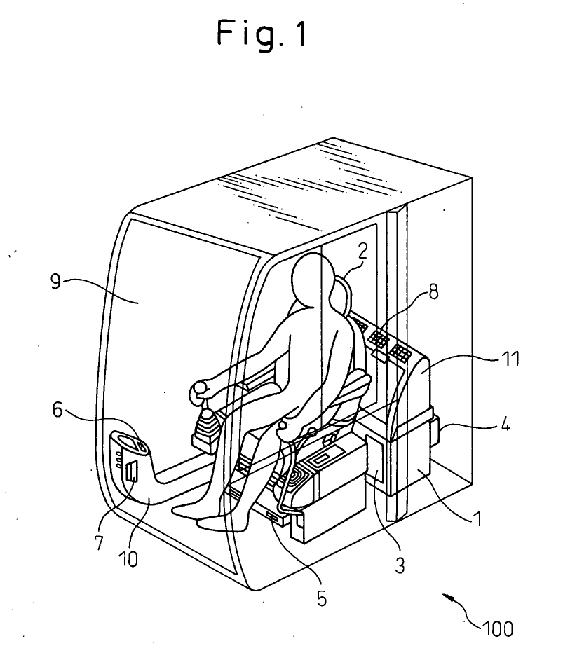

FIG. 1 shows an arrangement view of an operator cab 100 of a construction vehicle having an air conditioner for a vehicle according to the present invention.

As shown in FIG. 1, a seat for an operator is arranged in an operator cab 100. In a rear lower portion of the seat, an air conditioner 1 is arranged. The air conditioner 1 takes in air from the operator cab 100 through an inside air suction port 3, which is arranged close to the air conditioner 1 and provided with an opening directed toward the operator cab 100. In the same manner, the air conditioner 1 takes in air from the outside of the operator cab 100 through an outside air suction port 4, which is provided with an opening directed outside of the operator cab 100. The air conditioner 1 heats or cools air taken in through the inside air suction port 3 or the outside air suction port 4. A foot blowout port (FOOT) 5 arranged in a portion close to the foot of the operator, a face blowout port (FACE) 6 arranged close to a windshield 9 and open toward the operator, a defroster blowout port (DEF) 7 having an opening directed toward the windshield 9 and a rear blowout port (REAR) 8 having an opening directed upward from the rear of the seat 2, are arranged in the operator cab 100. The face blowout port 6 and the defroster blowout port 7 are connected to the air conditioner 1 through a front duct 10. In the same manner, the rear blowout port 8 is connected to the air conditioner 1 through a rear duct 11. Air heated or cooled by the air conditioner 1 is sent out from each blowout port arranged in the operator cab 100, so that the temperature in the operator cab 100 can be adjusted or the windshield 9 can be defogged.

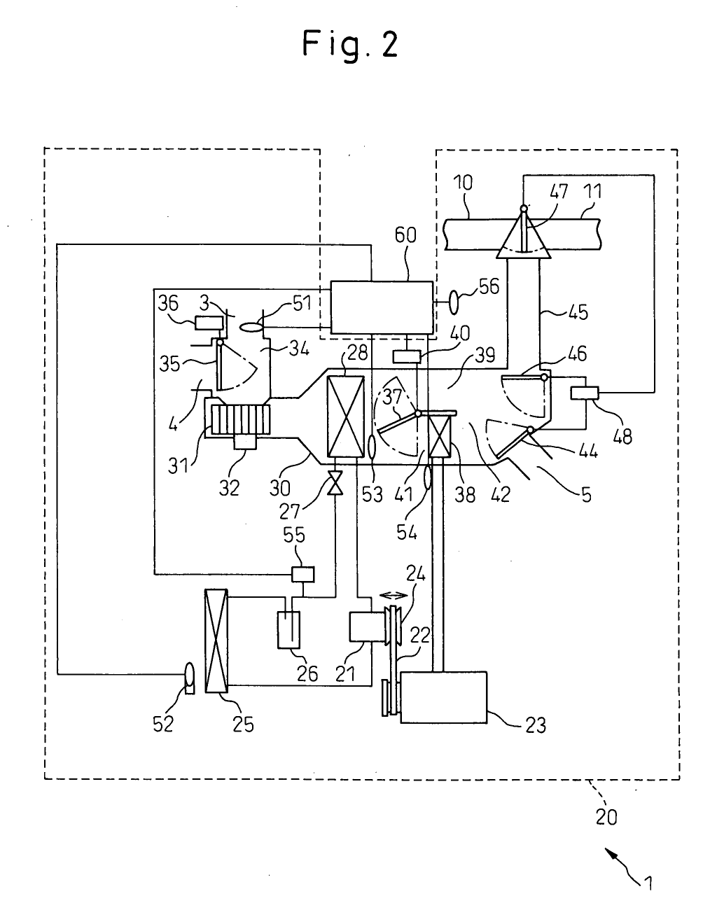

FIG. 2 shows an overall arrangement view of the air conditioner 1 for a vehicle. As shown in FIG. 2, the air conditioner 1 comprises: an air conditioning device 20 having a mechanical constitution, and a controller 60 for controlling the air conditioning device 20.

First, a constitution of the refrigerating cycle R of the air conditioning device 20 will be explained below. The refrigerating cycle R of the air conditioner 1 is composed of a closed cycle. The closed cycle includes a compressor 21, a condenser 25, a receiver 26, an expansion valve 27 and an evaporator 28. These components are arranged clockwise in the order of the compressor 21, the condenser 25, the receiver 26, the expansion valve 27 and the evaporator 28. The compressor 21 compresses refrigerant so as to make high pressure gas. The compressor 21 has an electromagnetic clutch 24 which is used for transmitting or shutting off power transmitted from vehicle engine 23 through a belt 22. The condenser 25 cools and liquidizes refrigerant gas of a high temperature and pressure sent from the compressor 21. The receiver 26 stores the liquidized refrigerant so as to adjust the amount of refrigerant circulating in the refrigerating cycle R. In order to prevent the cooling performance from deteriorating, the receiver 26 removes bubbles contained in the liquidized refrigerant and only liquidized refrigerant is sent to the expansion valve 27. The expansion valve 27 adiabatically expands the liquidized refrigerant so that the temperature and pressure of the refrigerant can be reduced. After that, the low temperature and pressure refrigerant is sent to the evaporator 28. In the evaporator 28, heat is exchanged between the refrigerant and the air sent to the evaporator 28, so that the air can be cooled.

Next, a constitution inside the air conditioning case 30 of the air conditioning device 20 will be explained below. A blower 31 is arranged on the upstream side of the evaporator 28. The blower 31 is composed of a centrifugal fan and driven by a drive motor 32. An inside and outside air changeover box 34 is arranged on the suction side of the blower 31. An inside and outside air changeover door 35, which is driven by an inside and outside servo motor 36, is arranged in the inside and outside air changeover box 34. The inside and outside air changeover door 35 changes over between the inside air suction port 3 and the outside air suction port 4 and opens and closes the inside air suction port 3 and the outside air suction port 4. Air, which has been taken in through the inside air suction port 3 or the outside air suction port 4, is sent to the evaporator 28 by the blower 31 through the inside and outside air changeover box 34. In this connection, when the rotating speed of the blower 31 is adjusted, the volume of air sent out from the air conditioner 1 can be adjusted.

On the downstream side of the evaporator 28, an air mixing door 37 and a heater core 38 are arranged in this order from the evaporator 28 side. In order to heat air passing through the heater core 38, coolant used for cooling the vehicle engine 23 is supplied to the heater core 38 being circulated (i.e. the coolant is a medium for supplying heat to the heater core 38). In the air conditioning case 30, a bypass passage 39 is arranged which bypasses the heater core 38. The air mixing door 37 is rotated by a temperature control servo motor 40 so as to adjust a ratio of the volume of hot air, which is sent from the passage 41 passing through the heater core 38, to the volume of cold air passing through the bypass passage 39 so that air temperature sent out from each blowout port can be adjusted at a predetermined value.

On the downstream side of an air mixing unit 42 in which cold air passing through the bypass passage 39 and hot air sent from the passage 41 passing through the heater core 38 are mixed with each other, a foot door 44 for opening and closing the foot blowout port 5 and a duct opening and closing door 46 for opening and closing an entrance of the duct 45, which is communicated with the face opening portion 6 and the rear opening portion 8, are arranged. In the duct 45, a front duct 10, which is communicated with the face opening portion 6 and the defroster opening portion 7, and a front and rear air distribution adjustment door 47 for adjusting the volume of air flowing to the rear duct 11 communicated with the rear opening portion 8 are arranged. The doors 44, 46, 47 are driven by a mode servo motor 48.

Next, various sensors incorporated into the air conditioner 1 will be explained below. An inside air temperature sensor 51 is arranged in an opening portion on the inside air suction port 3 side of the inside and outside air changeover box 34 so as to measure temperature Tᵢ in the operator cab. An outside air temperature sensor 52 is arranged in the periphery of the operator cab so as to measure the temperature Tₒ outside the operator cab. In this connection, the outside air temperature sensor 52 may be arranged on the front face of the condenser 25. In order to measure the temperature of air blown out from the evaporator 28, that is, in order to measure the evaporator blowout temperature Tₑ, an evaporator outlet temperature sensor 53 is arranged in the periphery of the outlet of the air passage on air mixing door 37 side of the evaporator 28. In the periphery of the inlet of the engine coolant to the heater core 38, a heater inlet temperature sensor 54 for measuring coolant temperature T_{w} is arranged.

A pressure sensor 55 for measuring the pressure P of the refrigerant, which circulates in a refrigerating cycle R, is attached in the periphery of the outlet of the receiver 26. Further, in order to measure an the intensity L of sunlight shining in the operator cab, a sunlight sensor 56 is attached to the periphery of the windshield of the operator cab. In this connection, the sunlight sensor 56 is composed of an illuminance sensor.

The sensors 51 to 56 described above are connected to the controller 60 capable of communicating with the controller 60. A measurement value acquired by each sensor is sent to the controller 60. The controller 60 controls the electromagnetic clutch 24 according to the measurement values and the operation signal acquired by A/C operation panel (not shown) so as to turn on and off the compressor 21. Further, the controller 60 controls a rotating speed of the blower 31 by controlling the drive motor 32. Furthermore, the controller 60 controls an inside and outside air servo motor 36, a temperature control servo motor 40 and a mode servo motor 48 so as to adjust a degree of opening of each door. When the controller 60 conducts controlling as described above, the temperature and volume of air of the hot air or cold air blown out from each blowout port are adjusted so that a temperature in the operator cab can become close to the setting temperature which has been set by the operator.

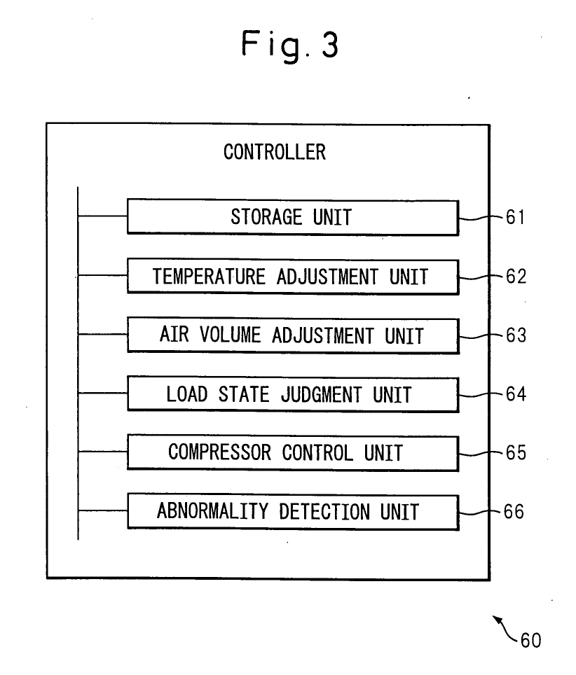

FIG. 3 shows a functional block diagram of the controller 60 of the air conditioner 1 for vehicle.

The controller 60 comprises: one or a plurality of microcomputers composed of a CPU, ROM and RAM not shown in the drawing; peripheral circuits of the microcomputers; and a storage unit 61 such as a nonvolatile memory which can be electrically rewritten.

The controller 60 further comprises: a temperature adjustment unit 62; an air volume adjustment unit 63; a load state judgment unit 64; a compressor control unit 65; and an abnormality detection unit 66, wherein these units are functional modules which are implemented by the microcomputer and by a computer program executed in the microcomputer. These units will be explained below.

The temperature adjustment unit 62 determines the degrees of the openings of the inside and outside air changeover door 35, the air mixing door 37 and the doors 44, 46, 47 for adjusting the volume of air blown out from each blowout port, based on a setting temperature Tₛ acquired from A/C operation panel and also according to measurement signals of the temperature sensors 51 to 53, the coolant temperature sensor 54 and the sunlight sensor 56. The temperature adjustment unit 62 sends a control signal to each servo motor for driving each door so that the degree of opening of each door can be a predetermined position. For example, the temperature adjustment unit 62 decides the degree of opening of the air mixing door 37 according to a relational equation, the output of which is the degree of opening of the air mixing door 37, when a value, which is obtained when a difference between the inside air temperature Ti and the setting temperature T_{S} is corrected by the outside temperature Tₒ and the quantity of sunlight L, is used as an input. In this case, the temperature adjustment unit 62 can stably control the degree of the opening of the air mixing door 37 at regular time intervals (for example, for each second) and when consideration is given to each measurement value obtained at the judgment time in the past. A relational equation between each measurement value and the degree of opening of the air mixing door 37 for conducting control is shown as follows.

$${Y}_{n} = α {\sum }_{j = 1}^{n - 1} [ {Ti}_{j} - ( {Ts}_{j} + β {To}_{j} + γ {L}_{j} ) ] + {Ti}_{n} - ( {Ts}_{n} + β {To}_{n} + γ {L}_{n} )$$

$$Do = {aY}_{n} + b$$

In the above equation, Dₒ expresses a degree of opening of the air mixing door 37. Coefficients α, β, γ, a and b are constants. Tₛⱼ, Tᵢⱼ, Tₒⱼ, Lⱼ (j=1, 2, . . . , n) respectively represent a setting temperature, inside air temperature, outside air temperature and a quantity of sunlight at the time of the measurement made by J times. However, the degree of the opening Dₒ of the air mixing door 37 is set in such a manner that the degree of opening Dₒ of the air mixing door 37 is 100% when the passage 41 passing through the heater core 38 is closed, that is, only when the cooling operation is conducted and the degree of opening Dₒ of the air mixing door 37 is 0% when the bypass passage 39 is closed, that is, only the heating operation is conducted.

In this connection, the temperature adjustment unit 62 may decide the degree of the opening of each door by the other well known control method.

The air volume adjustment unit 63 decides a rotating speed of the blower 31 according to the setting temperature acquired from A/C operation panel, the air volume setting and the measurement signals of the temperature sensors 51 to 53 and the sunlight sensor 56. The air volume adjustment unit 63 sends a control signal to the drive motor 33 so that the rotating speed of the blower 31 can be a setting value. For example, in the case where the air volume is set manually, the air volume adjustment unit 63 decides a rotating speed of the blower 31 so that the air volume can be a setting value acquired from A/C control panel. In the case where the air volume is set automatically, the air volume adjustment unit 63 decides a rotating speed of the blower 31 according to the relational expression expressing a relation between the inside air temperature and the setting temperature. This relational expression is previously set and incorporated into a computer program executed in the controller 60. In this connection, the air volume adjustment unit 63 can decide a rotating speed of the blower 31 by the other well known method.

The load state judgment unit 64 judges whether cooling operation is to be conducted or heating operation is to be conducted according to setting temperature Tₛ, which has been acquired from A/C operation panel, and also according to measurement signals of the temperature sensors 51 to 53 and the sunlight sensor 56. As described later, when a load of the air conditioner 1 for a vehicle is known, stopping the compressor can be only mitigated in the case where the air conditioner 1 for a vehicle bears a heating load. Therefore, the controller 60 can stop the refrigerating cycle R at the time of heating while refrigerating cycle R is prevented from being frequently stopped at the time of cooling operation.

For example, in the case where the setting temperature Tₛ is higher than the inside air temperature Tᵢ, the load state judgment unit 64 judges that it is a heating load. On the contrary, in the case where the inside air temperature Tᵢ is not less than the setting temperature Tₛ, the load state judgment unit 64 judges that it is not a heating load. Alternatively, the load state judgment unit 64 may judge whether or not it is a heating load according to the degree of opening of the air mixing door 37 found by the above temperature adjustment unit 62. For example, in the case where the degree of opening of the air mixing door 37 is set in such a manner that the passage 41 on the heater core 38 side is wider than the bypass passage 39, the load judgment unit 64 judges that it is a heating load. In the case where the degree of opening of the air mixing door 37 is not set in such a manner that the passage 41 on the heater core 38 side is wider than the bypass passage 39, the load judgment unit 64 judges that it is not a heating load.

In the case where the setting of heating and/or cooling is manually set by an operator, the load state judgment unit 64 judges whether or not it is a heating load by referring to a heating/cooling changeover signal sent from A/C operation panel.

For example, the result of judgment is prescribed as a binary variable of 1 bit and stored in the storage unit 61 so that it can be referred by the other unit in the controller 60.

The compressor control unit 65 turns the compressor on and off according to the evaporator outlet temperature Tₑ and coolant temperature T_{w} at the heater core 38 inlet. In this connection, the evaporator 28 is frosted over when the temperature is decreased to 0° C. or less. When the evaporator 28 is frosted over, frost is generated among the fins of the evaporator 28. Therefore, air flow is blocked and it becomes impossible to sufficiently exchange heat. For the above reasons, in order to prevent the evaporator 28 from being frosted over, when the evaporator outlet temperature Tₑ is lowered to a frost limit temperature T_{f}, the compressor 21 is stopped. For example, the frost limit temperature T_{f} is set at about 1° C.

At the time of heating, when the refrigerating cycle R is operated for the purpose of dehumidifying or defogging, since air cooled by the evaporator 28 passes through the heater core 38, the engine coolant is cooled and it becomes impossible to obtain a sufficiently high heating effect. Therefore, in the case where coolant temperature T_{w} is not more than predetermined temperature T_{w2}, the compressor control unit 65 sets threshold temperature T_{off}, at which the compressor is stopped, at a value higher than frost limit temperature T_{f}. When the condition is mitigated so that the compressor can be easily stopped, it becomes possible to reduce a period of time in which refrigerating cycle R is operated at the time of heating. Accordingly, the air conditioner 1 has a sufficiently large heating capacity. Further, a period of time in which the compressor is operating is reduced. In accordance with the reduction of the period of time in which the compressor is operating, a load given to the vehicle engine is reduced and the air conditioner 1 can cut down on fuel consumption.

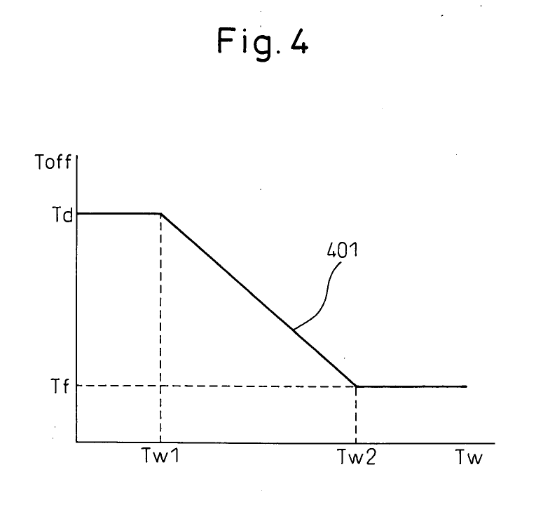

FIG. 4 shows a graph of the relationship between the coolant temperature T_{w} and the threshold temperature T_{off} at which the compressor is stopped. The axis of abscissas of the graph represents coolant temperature T_{w} and the axis of ordinate represents the threshold temperature. The graph 401 shown by a solid line expresses threshold temperature T_{off} found by coolant temperature T_{w}. As shown in FIG. 4, in the case where coolant temperature T_{w} is higher than predetermined coolant temperature T_{w2}, even if the air supplied to the heater core 38 is cooled, a sufficiently large heating capacity can be obtained. Accordingly, threshold temperature T_{off} is set at the same value as frost limit temperature T_{f}. When the coolant temperature T_{w} becomes lower than T_{w2}, threshold temperature T_{off} is gradually raised in accordance with a decrease in coolant temperature T_{w}. When the coolant temperature T_{w} is decreased to a value not more than a predetermined coolant temperature T_{w1}, the threshold temperature T_{off} becomes constant.

In the present embodiment, T_{w2} is set at the minimum temperature at which a temperature of hot air blown out from the foot blowout port 5 can be maintained at a value not less than a predetermined temperature (for example, 40° C.) in the case where threshold temperature T_{off} is set at the same value as frost limit temperature T_{f}. In the present embodiment, T_{w1} is set at a coolant temperature when evaporator outlet temperature Tₑ is raised to limit temperature T_{d} for defogging the windshield of the operator cab in the case where coolant temperature T_{w} is decreased while the above hot air temperature is being maintained at a predetermined temperature. Especially, in the case of a construction machine, only one person can usually occupy an operator cab. Therefore, compared with a common passenger car, less steam is generated in the operator cab of a construction vehicle. Further, the construction vehicle travels at a low speed. Therefore, the windshield of the operator cab is cooled less by the outside air than the windshield of a passenger car. Accordingly, a capacity of the refrigerating cycle R required for defogging may be relatively low. Therefore, the above limit temperature T_{d} becomes relatively high, that is, the above limit temperature T_{d} becomes 10° C. to 13° C. For the above reasons, according to the present embodiment, the air conditioner 1 can accomplish a sufficiently large heating capacity at the time of heating while the windshield is being sufficiently defogged. In this connection, T_{w1} and T_{w2} are not limited to the above specific temperatures. For example, in the case where priority is given to the heating capacity, T_{w2} may be set at a value higher than the above value by several degrees. In the case where priority is given to the defogging capacity, T_{w1} may be set at a value higher than the above value by several degrees so that threshold temperature T_{off} can be constant when evaporator outlet temperature Tₑ is lower than the above limit temperature T_{d} at which defogging can be executed.

The compressor control unit 65 acts according to a program into which the relational expression shown in the graph of FIG. 4 is incorporated. In the case where the load state, which is stored in the storage unit 61, is a heating load, the compressor control unit 65 decides threshold temperature T_{off} by the above relational expression being based on coolant temperature T_{w} acquired from the heater inlet coolant temperature sensor 54. In the case where evaporator outlet temperature Tₑ is not more than threshold temperature T_{off} found in this way, the compressor control unit 65 stops the compressor 21. That is, the electromagnetic clutch 24 is turned off so that motive power cannot be transmitted from the vehicle engine 23 to the compressor 21. On the other hand, in the case where the evaporator outlet temperature Tₑ is higher than the threshold temperature T_{off}, the compressor control unit 65 makes the compressor 21 continue to operate.

In this connection, in the case where the coolant temperature T_{w} is lower than the temperature T_{w2} described above, the compressor control unit 65 may set the threshold temperature T_{off} at a value in which a constant bias is added to the frost limit temperature T_{f}.

In the case where the load state stored in the storage unit 61 is not a heating load, the compressor control unit 65 stops the compressor 21 when evaporator outlet temperature Tₑ is not more than frost limit temperature T_{f}. On the other hand, when evaporator outlet temperature Tₑ is higher than the frost limit temperature T_{f}, the compressor control unit 65 makes the compressor 21 continue to operate.

After the compressor 21 has been stopped once, the compressor control unit 65 restarts the compressor 21 when the temperature of the evaporator 28 has somewhat increased. That is, the electromagnetic clutch 24 is connected and power is transmitted from the vehicle engine 23 to the compressor 21. Therefore, the compressor control unit 65 sets a temperature, which is higher than the threshold temperature to stop the compressor by a predetermined value, as the compressor operation start temperature Tₒₙ. For example, compressor operation start temperature Tₒₙ can be a threshold temperature T_{off} at the time of the heating load. Further, the compressor operation start temperature Ton can be a value in which 5° C. is added to the frost limit temperature T_{f} at the time of the not-heating load. The compressor control unit 65 compares the evaporator outlet temperature Tₑ with the compressor operation start temperature Ton. When the evaporator outlet temperature Tₑ exceeds the compressor operation start temperature Ton, the compressor control unit 65 makes the compressor 21 restart.

The abnormality detection unit 66 monitors the pressure of the refrigerant circulating in refrigerating cycle R, and detect an abnormality occurred in refrigerating cycle R. Therefore, in the case where the pressure P of the refrigerant measured by the pressure sensor 55 exceeds a predetermined upper limit threshold value or alternatively pressure P of the refrigerant measured by the pressure sensor 55 does not exceed a predetermined lower limit threshold value, the abnormality detecting unit 66 judges that an abnormality has been generated in refrigerating cycle R. In the case where it is judged that an abnormality has been generated in the refrigerating cycle R, the abnormality detection unit 66 separates the electromagnetic clutch 24 so as to stop the compressor 21. The abnormality detection unit 66 may display the occurrence of an abnormality, for example, on an operation panel (not shown) arranged in an operator cab.

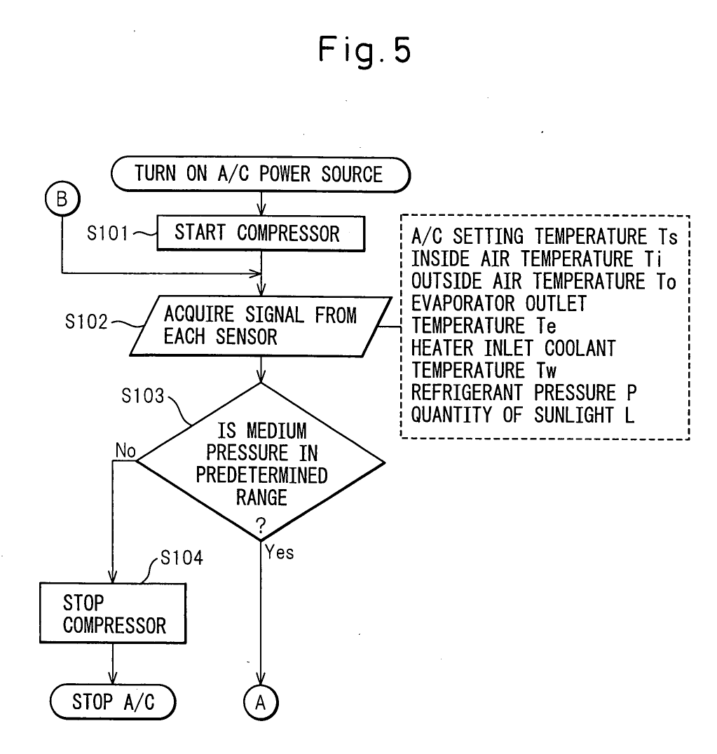

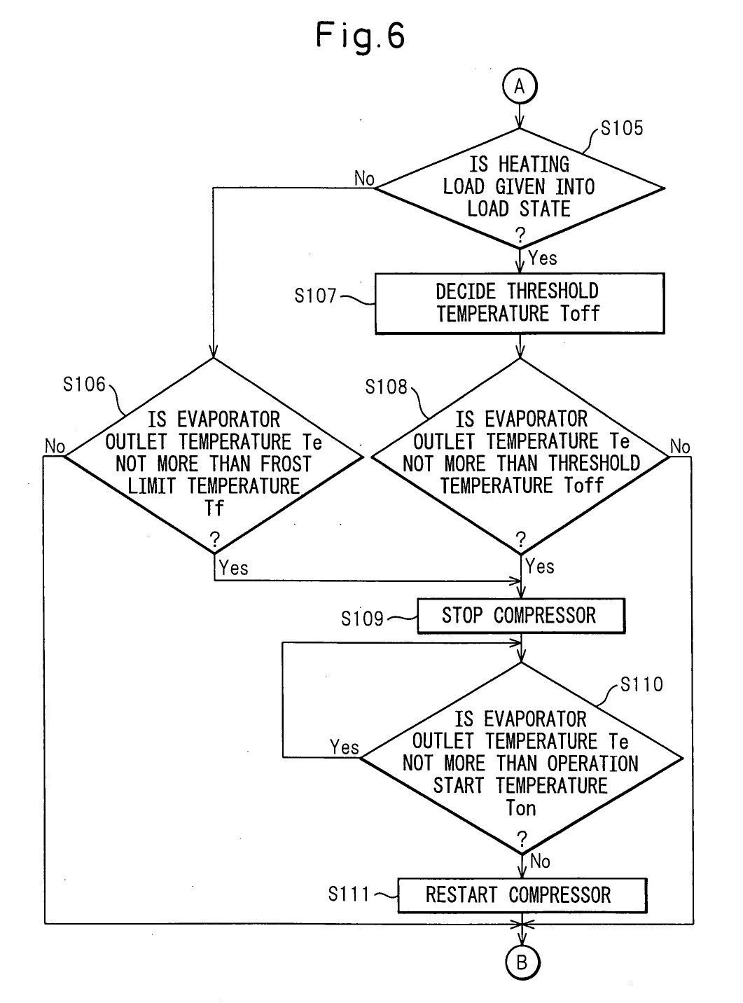

Referring to the flow chart shown in FIGS. 5 and 6, the control operation of the compressor 21 of the air conditioner 1 according to the present invention, will be explained below. The control operation of the compressor 21 explained here is mainly used in the case where the air conditioner 1 for vehicle operates in an automatic mode. In this connection, the control operation of the compressor 21 is conducted by the controller 60 according to a computer program incorporated into the controller 60.

As shown in FIG. 5, when the controller 60 receives a signal from the A/C operation panel, the controller 60 starts the air conditioner 1 for the vehicle. In order to conduct defogging or cooling, the controller 60 sets the compressor 21 in motion (step S101). After the air conditioner 1 has been started, the controller 60 acquires the setting temperature T₅, outside air temperature Tₒ, inside air temperature Tᵢ, evaporator outlet temperature Tₑ, heater inlet coolant temperature T_{w}, refrigerant pressure P and sunlight quantity L from the respective sensors (step 102). The abnormality detection unit 66 of the controller 60 judges whether or not the refrigerant pressure P of the refrigerating cycle R, which is acquired from the pressure sensor 55 as described above, is accommodated in a predetermined range (step S103). In the case where the refrigerant pressure P of refrigerating cycle R is not in the predetermined range, the abnormality detection unit 66 judges that refrigerating cycle is abnormal and stops the compressor 21 (step S104). In this way, the air conditioner 1 is stopped. On the other hand, in the case where refrigerant pressure P is in the predetermined range in step S103, the abnormality detection unit 66 judges that the refrigerating cycle R is normal.

As shown in FIG. 6, in the case where the refrigerating cycle R has been judged normal, the load state judgment unit 64 of the controller 60 judges whether or not the air conditioner 1 is in a heating load state, that is, the load state judgment unit 64 of the controller 60 judges whether or not a heating operation is performed (step S105). In the case where the load state is not a heating load, the compressor control unit 65 of the controller 60 compares evaporator outlet temperature Tₑ with frost limit temperature T_{f} (step S106). In the case where evaporator outlet temperature Tₑ is higher than the frost limit temperature T_{f}, the controller 60 returns the control to step S102. After a predetermined period of time has passed, the controller 60 performs step S102 and the following steps. On the other hand, in the case where evaporator outlet temperature Tₑ is not higher than the frost limit temperature T_{f}, in order to avoid frosting of the evaporator, the compressor control unit 65 stops the compressor 21 (step S109).

In step S105, when it is judged that the load state is a heating load as described above, the compressor control unit 65 decides the threshold temperature T_{off} according to the coolant temperature T_{w} at the inlet of the heater core 38 (step S107). Then, the compressor control unit 65 compares the threshold temperature T_{off} with the evaporator outlet temperature Tₑ (step S108). In the case where the evaporator outlet temperature Tₑ is higher than the threshold temperature T_{off}, the controller 60 returns the control to the previous step S102. After a predetermined period of time has passed, the controller 60 performs step S102 and the following steps. On the other hand, in the case where the evaporator outlet temperature Tₑ is not higher than threshold temperature T_{off}, in order to prevent the temperature of the engine coolant circulating in the heater core 38 from decreasing, the compressor control unit 65 stops the compressor 21 (step S109).

After the completion of step S109, after a predetermined period of time has passed, the compressor control unit 65 compares the evaporator outlet temperature Tₑ with the compressor operation start temperature Tₒₙ (step S110). In the case where the evaporator outlet temperature Tₑ is higher than the compressor operation start temperature Tₒₙ, the compressor control unit 65 restarts the compressor 21 (step S111). On the other hand, in the case where the evaporator outlet temperature Tₑ is not higher than the compressor operation start temperature Tₒₙ, while the compressor 21 is stopped, the compressor control unit 65 returns the control to the previous step S110. After a predetermined period of time has passed, processing of step S110 is executed again.

As explained above, in the air conditioner 1 for a vehicle according to the present invention, when the threshold temperature to stop the compressor is set at a value higher than the evaporator frost limit temperature based on the temperature of the engine coolant supplied to the heater core, the period of time in which the compressor is stopped can be extended and the temperature of air flowing into the heater core can be prevented from decreasing. As a result, heating capacity can be enhanced. The air conditioner 1 for the vehicle can extend a period of time in which the compressor is stopped. Accordingly, fuel consumption can be enhanced. Further, it is judged whether or not the load given to the air conditioner is a heating load. In the case where it is not a heating load, when the threshold temperature is fixed at the frost limit temperature, it is difficult for the compressor to be stopped at the time of cooling. Therefore, it is possible to sufficiently perform cooling.

In this connection, it should be noted that the present invention is not limited to the above specific embodiment.

For example, when the compressor control unit 65 decides the threshold temperature T_{off} at which the compressor 21 is stopped, the compressor control unit 65 may refer to the temperature of the coolant at the outlet of the heater core 38, the temperature of the coolant in the periphery of the vehicle engine 23 or the speed of the vehicle engine 23 instead of referring to the temperature of the coolant at the inlet of the heater core 38. These values have a constant correlation with the temperature T_{w} of coolant at the inlet of the heater core 38. Therefore, when the temperature T_{w} of coolant at the inlet of the heater is estimated based on the correlation, these values can be treated in the same manner as that of coolant temperature T_{w}. Instead of the evaporator outlet temperature Tₑ, it is possible to use the surface temperature of a cooling fin or a tube of the evaporator 28. Alternatively, it is possible to use a value decided based on a correlation between the refrigerant pressure in the periphery of the refrigerating cycle R of the evaporator 28 and the rotating speed of the compressor 21. In the case where a variable displacement compressor is used for the compressor 21, compressor volume may be used instead of the outlet temperature Tₑ of the evaporator. Since these values have a constant correlation with the outlet temperature Tₑ of the evaporator, when the outlet temperature Tₑ of the evaporator is estimated according to the correlation, these values can be treated in the same manner as that of the outlet temperature Tₑ of the evaporator.

In the embodiment described above, when outlet temperature Tₑ of the evaporator is not more than the threshold temperature T_{off}, the controller 60 makes the compressor stop. However, in the case where outlet temperature Tₑ of the evaporator is not higher than the threshold temperature T_{off} and not higher than the frost limit temperature T_{f}, the controller may control the compressor so that the compressor capacity can be reduced, for example, the rotating speed of the compressor can be reduced.

In the case where the aforementioned coolant temperature is reduced lower than T_{w2}, the air volume adjustment unit 63 may reduce the rotating speed of the blower 31 so as to decrease the volume of air sent out from each blowout port and raise the temperature of air blown out from each blowout port. When control is conducted in this way, the operator can be made more comfortable at the time of heating.

As described above, variations can be made in the scope of the present invention.

What is claimed is:

1. An air conditioner comprising:
a compressor for compressing refrigerant;
a condenser for cooling the refrigerant compressed by said compressor;
an expansion valve for adiabatically expanding the refrigerant cooled by said condenser;
an evaporator for exchanging heat between the refrigerant, which has been adiabatically expanded by said expansion valve, and air;
a first sensor for acquiring information related to a temperature of the evaporator;
a heater core for heating the air that has passed through said evaporator;
a second sensor for acquiring information related to a temperature of a medium for supplying heat to said heater core; and
a compressor control unit for controlling said compressor, wherein
when a temperature of said evaporator, which is estimated according to the information acquired from said first sensor, is not more than a predetermined threshold temperature, said compressor control unit reduces a ratio of compression of the refrigerant by said compressor, and when a temperature of the medium, which is estimated according to the information acquired from said second sensor, is not more than a first predetermined value, said compressor control unit sets the threshold temperature at a value higher than a frost limit temperature of said evaporator.

2. An air conditioner according to claim 1, wherein the first predetermined value is a minimum value of the medium temperature capable of maintaining a temperature of air sent out from the air conditioner at a value not less than a predetermined value in the case where the evaporator temperature is the frost limit temperature.

3. An air conditioner according to claim 1, wherein said compressor control unit sets the threshold temperature at a higher value as the medium temperature is decreased to be lower than the first predetermined value.

4. An air conditioner according to claim 3, wherein said compressor control unit sets the threshold temperature at a constant value in the case where the medium temperature is not more than a second predetermined value lower than the first predetermined value.

5. An air conditioner according to claim 4, wherein the second predetermined value is a maximum temperature of said evaporator capable of defogging a windshield arranged in a region to be air-conditioned by the air conditioner.

6. An air conditioner according to claim 1, further comprising:
a load state judgment unit for judging whether or not a load given to the air conditioner is a heating load, and
wherein said compressor control unit sets the threshold temperature at the frost limit temperature of said evaporator in the case where said load state judgment unit judges that the load given to the air conditioner is not a heating load.

7. A construction vehicle having an air conditioner for conditioning air in an operator cab of the construction machine,
said air conditioner comprising:
a compressor for compressing refrigerant;
a condenser for cooling the refrigerant compressed by said compressor;
an expansion valve for adiabatically expanding the refrigerant cooled by said condenser;
an evaporator for exchanging heat between the refrigerant, which has been adiabatically expanded by said expansion valve, and air;
a first sensor for acquiring information related to a temperature of said evaporator;
a heater core for heating the air that has passed through said evaporator;
a second sensor for acquiring information related to a temperature of a medium for supplying heat to said heater core; and
a compressor control unit for controlling said compressor, wherein
when a temperature of said evaporator, which is estimated according to the information acquired from said first sensor, is not more than a predetermined threshold temperature, said compressor control unit reduces a ratio of compression of the refrigerant by said compressor, and when a temperature of the medium, which is estimated according to the information acquired from said second sensor, is not more than a first predetermined value, said compressor control unit sets the threshold temperature at a value higher than a frost limit temperature of said evaporator.

8. A construction vehicle according to claim 7, wherein
the first predetermined value is a minimum value of the medium temperature capable of maintaining a temperature of air sent out from the air conditioner at a value not less than a predetermined value in the case where the evaporator temperature is the frost limit temperature.

9. A construction vehicle according to claim 7, wherein
said compressor control unit sets the threshold temperature at a higher value as the medium temperature is decreased to be lower than the first predetermined value.

10. A construction vehicle according to claim 9, wherein
said compressor control unit sets the threshold temperature at a constant value in the case where the medium temperature is not more than a second predetermined value lower than the first predetermined value.

11. A construction vehicle according to claim 10, wherein
the second predetermined value is a maximum temperature of said evaporator capable of defogging a windshield arranged in a region to be air-conditioned by the air conditioner.

12. A construction vehicle according to claim 7, further comprising:
a load state judgment unit for judging whether or not a load given to the air conditioner is a heating load, and
wherein said compressor control unit sets the threshold temperature at the frost limit temperature of said evaporator in the case where said load state judgment unit judges that the load given to the air conditioner is not a heating load.

13. A method for controlling an air conditioner,
the air conditioner comprising: a compressor for compressing refrigerant; a condenser for cooling the refrigerant compressed by said compressor; an expansion valve for adiabatically expanding the refrigerant cooled by said condenser; an evaporator for exchanging heat between the refrigerant, which has been adiabatically expanded by said expansion valve, and air; and a heater core for heating the air that has passed through said evaporator,
the method comprising:
acquiring said evaporator temperature;
acquiring the medium temperature;
setting a threshold temperature, which decides whether or not a ratio of compression of the refrigerant by said compressor is reduced according to the medium temperature, at a value higher than the frost limit temperature of said evaporator in the case where the medium temperature is not more than the first predetermined value; and
reducing the ratio of compression of refrigerant by said compressor in the case where the temperature of said evaporator is not more than the threshold temperature.

14. A method according to claim 13, wherein the threshold temperature is set higher as the medium temperature is reduced to be lower than the first predetermined value.
